(19) United States
(12) Patent Application Publication
(10) Pub. No.: US 2002/0014765 A1
(43) Pub. Date: Feb. 7, 2002

(54) Gas bag

(75) Inventor: Norbert Ellerbrok, Rudersberg (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Occupant Restraint Systems GmbH & Co. KG

(21) Appl. No.: 09/833,852

(22) Filed: Apr. 12, 2001

(30) Foreign Application Priority Data
May 12, 2000 (DE) 200 08 542.5

(51) Int. Cl. B60R 21/16

(52) U.S. Cl. 280/743.1; 280/728.1

(57) ABSTRACT

The invention relates to a gas bag for a vehicle occupant restraint system, the gas bag comprising a gas bag wall which consists of at least one fabric piece, the latter including adjacent partial sections of fabric which are connected with each other by a seam. Further, the invention provides a gas bag of at least two fabric pieces. An uncoated sewing thread is provided by means of which the seam is formed and which is made of a plastic having a softening temperature of more than approximately 280° C.

### TECHNICAL FIELD

The invention relates to a gas bag for a vehicle occupant restraint system.

### BACKGROUND OF THE INVENTION

The gas bag of a restraint system in vehicles is inflated within a few milliseconds in a vehicle collision and serves as an impact protection cushion for the vehicle occupant. Such a gas bag is produced from one or more fabric pieces which are sewn to each other at their outer edges. Hitherto, gas bags have been known which are sewn with sewing threads of polyamide 6.6 or polyester. In order to make the sewn seams resistant with respect to high stresses by traction and temperatures, various seam types are used for this in accordance with DIN ISO 4916. Through the gases emerging from the generator, temperatures of approximately 600° to 700° C. can be reached in the entire gas bag. These temperatures lie far above the melting points of the gas bag fabric and of the sewing threads. The melting- or decomposition temperature of fibers of polyamide 6.6 is 260° C. and that of fibers of polyester up to 295° C. As the surface of the gas bag fabric is smooth and the period of action of the hot gases on the gas bag fabric is only short, damage to the gas bag fabric generally does not occur. The sewing thread, however, has a distinctly higher surface/volume ratio, so that the thermal stressing leads substantially more frequently to a failure of the seams than to a failure of the fabric. According to the prior art, therefore, coatings are applied onto the seams on the side facing the gas generator, in order to seal the gas bag and to achieve a greater stability with respect to intense thermal stressing. The application of such coatings, however, is not reliable with regard to the process and involves considerable costs.

### BRIEF SUMMARY OF THE INVENTION

The invention provides a gas bag in which the seam connection between the fabric pieces or partial sections of fabric is maintained even in the case of an intense thermal stressing and a tearing of the seam is avoided.

This is achieved in a gas bag which comprises a gas bag wall which consists of at least one fabric piece, the latter including adjacent fabric piece sections which are connected with each other by a seam. Further, the invention provides a gas bag with a gas bag wall of at least two fabric pieces. An uncoated sewing thread is provided by means of which the seam is formed and which is made of a plastic having a softening temperature of more than approximately 280° C. A melting- or decomposition temperature of this plastic amounts to at least 320° C. Thereby, it is achieved that the sewing threads no longer tear even in the case of intense thermal stressing and the gas bag remains intact in the case of restraint. The tearing strength of the sewing threads used, which are resistant to high temperatures, is approximately just as great as that of the sewing threads used hitherto.

Preferably the sewing thread consists of a material which has a softening temperature of more than approximately 300° C. or a melting- or decomposition temperature of 370° C. or more. This can, for example, be para-aramides, meta-aramides or polytetrafluor ethylene.

In a further preferred embodiment according to the invention, the gas bag is uncoated on the inner side in the region of the seam produced by means of the sewing thread, whereby further production costs are avoided. Although such a sewing thread is distinctly more expensive than conventionally used sewing threads, as a whole a more economical solution is achieved than in conventionally used sewing threads, because the seam does not have to be additionally sealed and the thread does not have to be coated.

### BRIEF DESCRIPTION OF THE DRAWINGS

FIG. 1 shows a diagrammatic view of an inflatable gas bag according to the invention for a restraint system in vehicles;

FIG. 2 shows a seam pattern of a seam connection in the gas bag according to FIG. 1;

FIG. 3 shows a section through the seam connection along the line A-A in FIG. 2;

FIG. 4 shows a diagrammatic view of a further embodiment of the gas bag according to the invention for a restraint system.

### DETAILED DESCRIPTION OF THE PREFERRED EMBODIMENTS

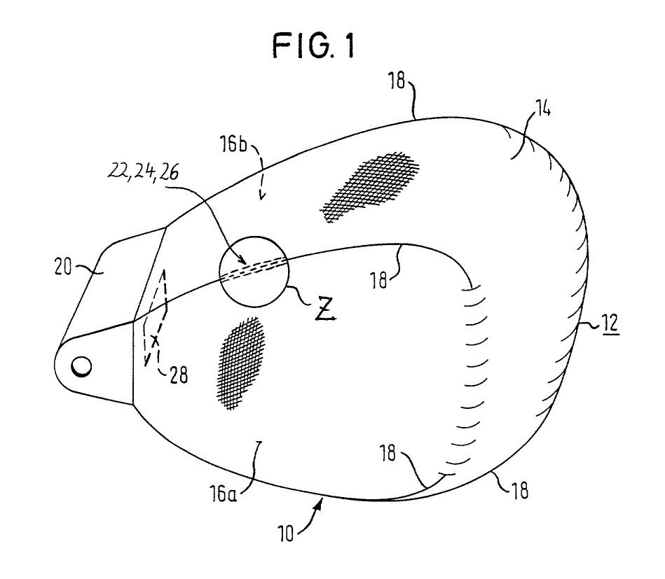

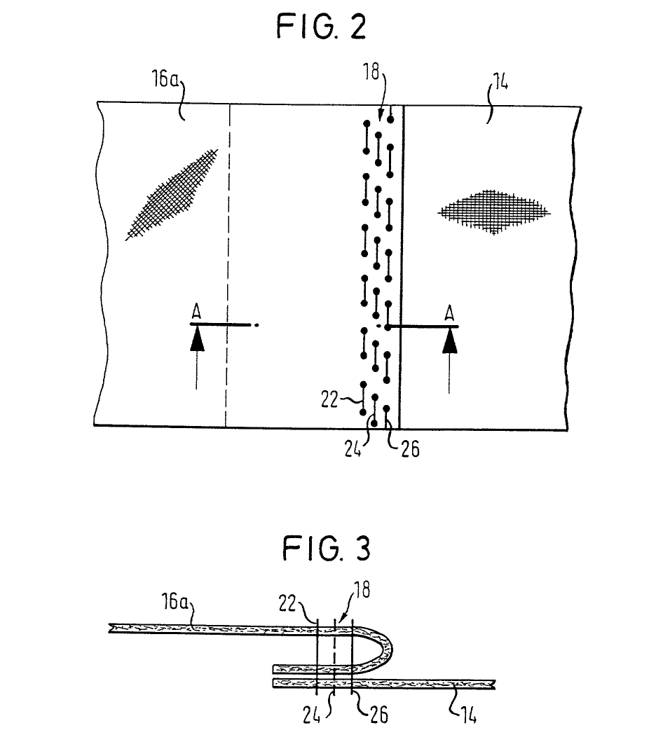

The gas bag 10 illustrated in FIG. 1 is formed from a fabric piece 12 which consists of a first fabric piece section 14 and two second fabric piece sections 16a and 16b. The first fabric piece section 14 and the two second fabric piece sections 16a and 16b are sewn together along their adjacent edges by seams 18. The seams 18 extend, starting from the housing 20, into that region of the gas bag which in the inflated state faces the occupant. The outlined are Z in FIG. 1 as well as FIGS. 2 and 3 show detailed illustrations of the seam 18 between the fabric piece sections 14 and 16a and the wall of the gas bag. The seam 18 connecting the two fabric piece sections 14 and 16a consists here by way of example of three individual seams running parallel and comprised of sewing threads 22, 24, 26. The sewing threads 22, 24 and 26 are of a plastic with a softening temperature of more than approximately 280° C. and are uncoated.

In a further preferred embodiment, the sewing threads 22, 24, 26 are formed from a material with a softening temperature of more than approximately 300° C.

Particularly advantageous materials for the sewing threads 22, 24, 26 are para-aramides (e.g. Nomex, a trademark of Du Pont), meta-aramides (e.g. Kevlar, a trademark of Du Pont) or polytetrafluor ethylene (e.g. Teflon, a trademark of Du Pont). The high softening temperatures of these materials lead to a particular stability of the seam connection with respect to thermal action and to an increased tearing strength of the seams.

The gas bag 10 is uncoated on the inner side in the region of the seams produced by means of the sewing threads 22, 24, 26. This leads to a lower number of production steps in manufacture and hence to a reduction of the overall production costs of the gas bag. Further advantages thereof are a reduced packing volume for the gas bag and a lower rigidity of the gas bag.

The sewing threads 22, 24, 26 also connect partial sections of fabric in the region of the inflation opening 28 of the gas bag 10, which are exposed to particularly high stresses through the thermal action of the hot gases of the generator which blow directly against them. Thus, in particular in these regions which are most intensively stressed thermally, a tearing of the gas bag can be avoided.

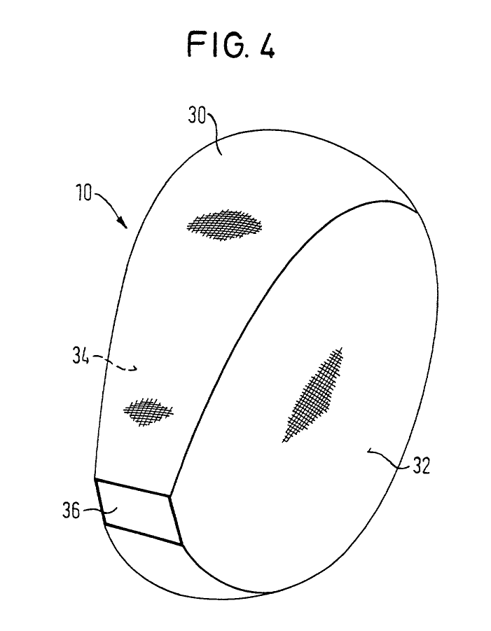

FIG. 4 shows a further preferred embodiment of a gas bag according to the invention. The wall of the gas bag 10 consists of three fabric piece sections which are separate fabric pieces connected with each other along their outer edge (partial sections of fabric) by means of a sewing thread with a softening temperature of more than approximately 280° C.: a cover piece 30 and two side pieces 32, 34. In the cover piece 30 an inflation opening 36 is formed, on the edge of which the gas bag 10 is connected with the housing of a gas generator.

The connection of the fabric pieces or fabric piece sections of the gas bag by means of sewing threads which are resistant to high temperatures ensures an increased seam strength and ability to undergo thermal stress in the seams with, at the same time, reduced production costs for the gas bag.

1. A gas bag for a vehicle occupant restraint system, said gas bag comprising a gas bag wall which consists of at least one fabric piece, the fabric piece including adjacent fabric piece sections which are connected with each other by a seam, an uncoated sewing thread being provided by means of which said seam is formed and which is made of a plastic having a softening temperature of more than approximately 280° C.

2. The gas bag according to claim 1, wherein said sewing thread is formed from a plastic having a softening temperature of more than approximately 300° C.

3. The gas bag according to claim 1, wherein said sewing thread consists of para-aramide, meta-aramide or polytetrafluor ethylene.

4. The gas bag according to claim 1, wherein said gas bag is uncoated on an inner side in a region of said seam produced by means of said sewing thread.

5. The gas bag according to claim 1, wherein said sewing thread connects with each other said fabric piece sections in a region of an inflation opening of said gas bag.

6. A gas bag for a vehicle occupant restraint system, said gas bag comprising a gas bag wall which consists of at least two fabric pieces, which are connected with each other by a seam, an uncoated sewing thread being provided by means of which said seam is formed and which is made of a plastic having a softening temperature of more than approximately 280° C.

7. The gas bag according to claim 6, wherein said sewing thread is formed from a plastic having a softening temperature of more than approximately 300° C.

8. The gas bag according to claim 6, wherein said sewing thread consists of para-aramide, meta-aramide or polytetrafluor ethylene.

9. The gas bag according to claim 6, wherein said gas bag is uncoated on an inner side in a region of said seam produced by means of said sewing thread.

10. The gas bag according to claim 6, wherein said sewing thread connects with each other said fabric pieces in a region of an inflation opening of said gas bag.
